(19) United States
(12) Patent Application Publication
(10) Pub. No.: US 2023/0103173 A1
(43) Pub. Date: Mar. 30, 2023

(54) MACHINE LEARNING ALGORITHM FOR CONTROLLING THERMAL COMFORT

(71) Applicant: Gentherm Incorporated, Northville, MI (US)

(72) Inventor: Ioannis Androulakis, Livonia, MI (US)

(21) Appl. No.: 17/800,667

(22) PCT Filed: Mar. 18, 2021
(86) PCT No.: PCT/US2021/022877

§ 371 Date: Aug. 18, 2022

Related U.S. Application Data
(60) Provisional application No. 63/012,335, filed on Apr. 20, 2020.

(51) Int. Cl. B60H 1/00; G06N 20/20

(52) U.S. Cl. CPC B60H 1/0073; B60H 1/00742; G06N 20/20

(57) ABSTRACT

A method of controlling an occupant microclimate system includes determining vehicle environmental conditions, determining occupant personal parameters, predicting a multiple of occupant thermal comfort values based upon at least the environmental conditions, cabin temperature data, and occupant personal parameters. The predicting is performed using a multiple of different machine learning algorithm relationships to provide the multiple of occupant thermal comfort values, evaluating the multiple of occupant thermal comfort values using a voting classifier to provide an estimated occupant thermal comfort, and regulating at least one thermal effector based upon the estimated occupant thermal comfort.

### CROSS-REFERENCE TO RELATED APPLICATION

This application claims priority to U.S. Provisional Patent No. 63/012,335 which was filed on Apr. 20, 2020. This application also incorporates by reference PCT Application No. PCT/US21/22876 filed on Mar. 18, 2021.

### BACKGROUND

Vehicles commonly include heating, ventilation and air conditioning (HVAC) systems to thermally condition air within the vehicle's cabin. A typical modern vehicle also includes seats having thermal effectors that are controlled to achieve occupant thermal comfort. The thermal effectors may include heating and/or cooling elements that further heat or cool the occupant through the seat support surfaces.

Although many systems have been proposed, it is difficult to achieve a commercial seating thermal control system that effectively and efficiently achieves occupant thermal comfort using the seat, particularly for all of the numerous variable conditions present in a vehicle cabin.

Thermal comfort is usually associated with one simple parameter such as the mean temperature. Although temperature is a major driver of thermal comfort it does a poor job in reflecting the perception of pleasantness/unpleasantness in people. This perception is regulated by multiple environmental parameters on one hand (temperature stratification, humidity, and radiation) and personal characteristics on the other (clothing level, height, weight, age, gender etc). Therefore, the driver of an automobile has to frequently regulate HVAC controls to account for the dynamic environment of the car cabin. The problem is aggravated in cases of multiple occupancy where multiple opinions come into play. There is a need for customization of comfort per occupied cabin seat.

Better approximations to the problem of thermal comfort in a car cabin have been implemented with the most notable being the equivalent homogenous temperature (EHT). EHT is a better measure of the environmental factors in the cabin. However, it does not address the component of personal characteristics and preferences. Still other attempts to solve the problem rely on expensive solutions such as infra-red thermal cameras to estimate skin temperature.

### SUMMARY OF THE INVENTION

An exemplary method of controlling an occupant microclimate system, the method including the steps of determining vehicle environmental conditions, determining occupant personal parameters, predicting a multiple of occupant thermal comfort values based upon at least the environmental conditions, cabin temperature data, and occupant personal parameters, the predicting step performed using a multiple of different machine learning algorithm relationships to provide the multiple of occupant thermal comfort values, evaluating the multiple of occupant thermal comfort values using a voting classifier to provide an estimated occupant thermal comfort, and regulating at least one thermal effector based upon the estimated occupant thermal comfort.

In another example of the above described method for controlling an occupant microclimate system the vehicle environmental conditions include at least one of cabin conditions, vehicle exterior temperature and vehicle exterior humidity.

In another example of any of the above described methods for controlling an occupant microclimate system the cabin conditions include at least two of the cabin temperature data, a cabin humidity and a cabin solar radiation.

In another example of any of the above described methods for controlling an occupant microclimate system the cabin conditions include at least three of mean temperature at a cabin floor, mean temperature at an occupant belt line or waist, mean temperature at a breath level or face, temperature of a cushion between knees, temperature of a seat back, temperature of a seat cushion, and a difference between the temperatures at the breath level and at the cabin floor.

In another example of any of the above described methods for controlling an occupant microclimate system the occupant personal parameters include at least two of occupant weight, occupant height, occupant gender, and occupant clothing.

In another example of any of the above described methods for controlling an occupant microclimate system the multiple of machine learning algorithms include at least three of random forests, LightGBM, Neural Nets, Extremely Gradient Boosted Trees (XGBoost), Extremely Randomized Trees, Adaptive boosting, Logistic Regression, Support Vector Machines, and Naive Bayes classifiers, the evaluating step performed on calculated equivalent homogeneous temperatures.

In another example of any of the above described methods for controlling an occupant microclimate system each of the multiple of machine learning algorithms is trained via identical training sets.

In another example of any of the above described methods for controlling an occupant microclimate system the voting classifier chooses among the multiple of occupant thermal comfort values using a majority hard-voting process to select the estimated occupant thermal comfort.

In another example of any of the above described methods for controlling an occupant microclimate system the voting classifier chooses among the multiple of occupant thermal comfort values using a probabilistic soft-voting process to select the estimated occupant thermal comfort.

In another example of any of the above described methods for controlling an occupant microclimate system the thermal effectors are selected from the group comprising a climate controlled seat, a head rest/neck conditioner, a climate controlled headliner, a steering wheel, a heated gear shifter, a heater mat, and a mini-compressor system.

In one exemplary embodiment a microclimate control system for an occupant includes a first input device configured to provide vehicle environmental conditions, a second input device occupant personal parameters, at least one thermal effector configured to heat and/or cool an occupant, and a controller configured to predict a multiple of occupant thermal comfort values based upon the environmental conditions, cabin temperature data, and occupant personal parameters, the controller configured to perform the prediction using a multiple of different machine learning algorithms to provide the multiple of occupant thermal comfort values, the controller configured to evaluate the multiple of occupant thermal comfort values with a voting classifier to provide an estimated occupant thermal comfort, the controller configured to regulate the at least one thermal effector based upon the estimated occupant thermal comfort.

In another example of the above described microclimate control system for an occupant the vehicle environmental conditions include at least one of cabin conditions, vehicle exterior temperature and vehicle exterior humidity.

In another example of the above described microclimate control system for an occupant the cabin conditions include at least two of the cabin temperature, a cabin humidity and a cabin solar radiation.

In another example of any of the above described microclimate control systems for an occupant the cabin conditions include at least three of a mean temperature at a cabin floor, a mean temperature at an occupant belt line or waist, a mean temperature at a breath level or face, a temperature of a cushion between the knees, a temperature of a seat back, a temperature of a seat cushion, and a difference between temperatures at the breath level and at the cabin floor.

In another example of any of the above described microclimate control systems for an occupant the second input device is at least one array of pressure sensors in a seat, and the occupant personal parameters include at least two of occupant weight, occupant height, occupant gender, and occupant clothing.

In another example of any of the above described microclimate control systems for an occupant the multiple of machine learning algorithms relationship ships include machine learning algorithm relationships determined using at least three of random forests, LightGBM, Neural Nets, Extremely Gradient Boosted Trees (XGBoost), Extremely Randomized Trees, Adaptive boosting, Logistic Regression, Support Vector Machines, and Naive Bayes classifiers, the evaluating step performed on calculated equivalent homogeneous temperatures.

In another example of any of the above described microclimate control systems for an occupant the voting classifier chooses among the multiple of occupant thermal comfort values based upon one of majority hard-voting and probabilistic soft voting to select the estimated occupant thermal comfort.

In another example of any of the above described microclimate control systems for an occupant the thermal effectors are selected from the group comprising a climate controlled seat, a head rest/neck conditioner, a climate controlled headliner, a steering wheel, a heated gear shifter, a heater mat, and a mini-compressor system.

In another example of any of the above described microclimate control systems for an occupant the multiple of machine learning algorithm relationships includes at least three machine learning relationships determined using a single machine learning algorithm and at least three data sets.

### BRIEF DESCRIPTION OF THE DRAWINGS

The disclosure can be further understood by reference to the following detailed description when considered in connection with the accompanying drawings wherein:

FIG. 1 is a block diagram of a neural network using inputs affecting occupant thermal comfort to establish a predicted neural network relationship between those inputs to provide an occupant thermal comfort output.

FIG. 2 is a simplified block diagram illustrating neural network training using the inputs illustrated in FIG. 1 to establish the relationship between the inputs and output for a given machine learning algorithm.

FIG. 3 is a flow chart depicting an example method of controlling an occupant microclimate system.

FIG. 4 is a schematic depicting a first vehicle microclimate control system.

FIG. 5 illustrates three example machine learning algorithm classifiers using the inputs and examples as to how voting using the classifiers may be employed.

FIG. 6 is a schematic depicting a second vehicle microclimate control system.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

This disclosure is directed to a method for capturing environmental and personal characteristics and making predictions of individual preferences of thermal satisfaction within the car cabin.

The system and method disclosed herein rely upon the readings from a grid of simple, inexpensive sensors, or inputs, and the output of transfer functions, where such sensors are lacking, to infer the thermal comfort state of an automobile passenger according to a relationship f(x). The prediction is based on multiple machine learning algorithms, which each are trained using a data set of the inputs and their associated occupant thermal comfort. Specifically, at least three different machine learning algorithms (e.g., random forests, LightGBM, Neural Nets, etc.) are trained to predict the thermal comfort state of a passenger. In one example, each machine learning algorithm is trained with identical data sets. Due to the distinct algorithms, the identical training data sets result in distinct machine learning algorithm relationships being determined. Each machine learning algorithm may predict a different occupant thermal comfort. The predictions from the algorithms are then passed through a voting classifier which predicts i) on majority hard-voting and/or ii) probabilistic soft-voting. The voting classifier determines which reduction is most accurate, and outputs the most accurate prediction. As a result, the accuracy of the predicted occupant thermal comfort is improved since multiple machine learning approaches are relied upon. The algorithms used in the prediction of thermal comfort are flexible and can be expanded to include other signals, such as heart rate variability parameters, and make inferences or decision on wellness preferences.

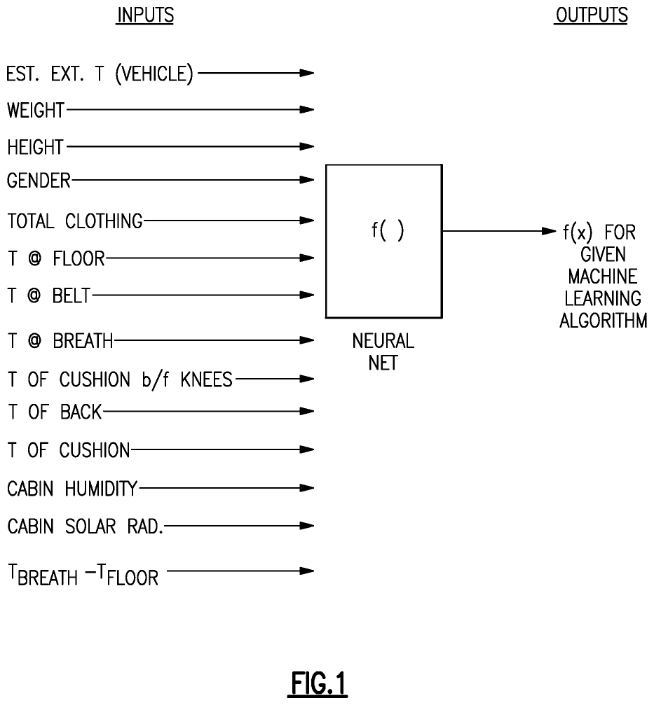

FIG. 1 is a simplified block diagram of a single example neural network. The neural network (f( ) performs a non-parametric, non-linear multivariate mapping from one set of parameters (inputs, x) to another (outputs, transfer function ƒ(x)). The output f(x) is the result of the mapping performed on the inputs by the neural network. In the illustrated examples, inputs that affect occupant thermal comfort are mapped to provide an output corresponding to occupant thermal comfort. Inputs include, for example, estimated external temperature taken from the CAN bus of the vehicle, occupant weight, occupant height, occupant gender, total occupant clothing, mean air temperature at the cabin floor, mean air temperature at the occupant belt line or waist, mean air temperature at the breath level or face, air temperature measured at the cushion between the knees, temperature of the seat back, temperature of the seat cushion, cabin humidity, cabin solar radiation, and/or the difference between the temperatures at the breath level and at the cabin floor. Additional or different inputs may be used in alternate example embodiments.

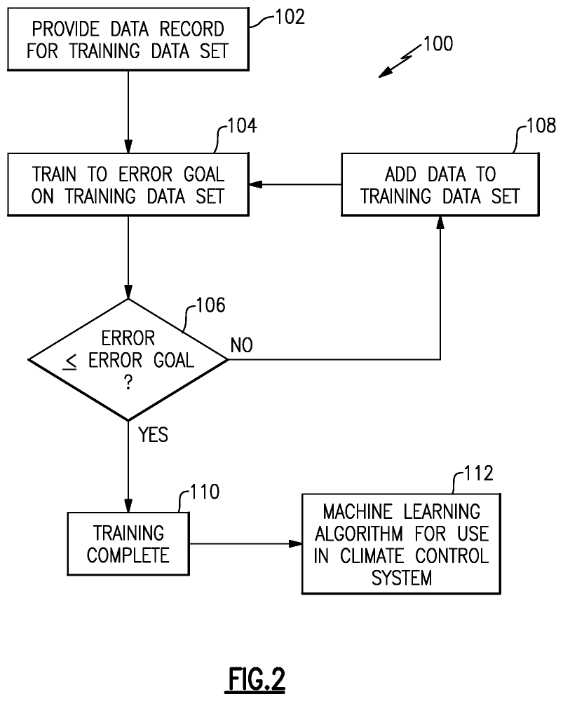

In order to determine the relationship f(x) between the inputs and occupant thermal comfort for a given machine learning algorithm, the machine learning algorithm is trained using a data set. Referring to FIG. 2, the training 100 begins by providing a segment of a large data record for training purposes, indicated at block 102. An algorithm is iteratively trained to a desired error (block 106), using additional data from the training data set (block 108), if necessary. The desired error is a likelihood of accuracy of the comfort determination. Once the error goal is achieved, the training is complete (block 110) and the machine learning algorithm relationship f(x) has been sufficiently established for use in a vehicle climate control system.

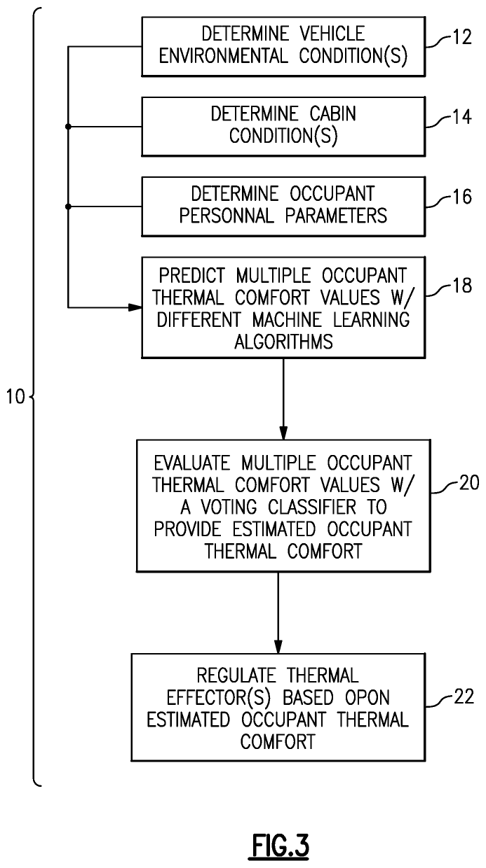

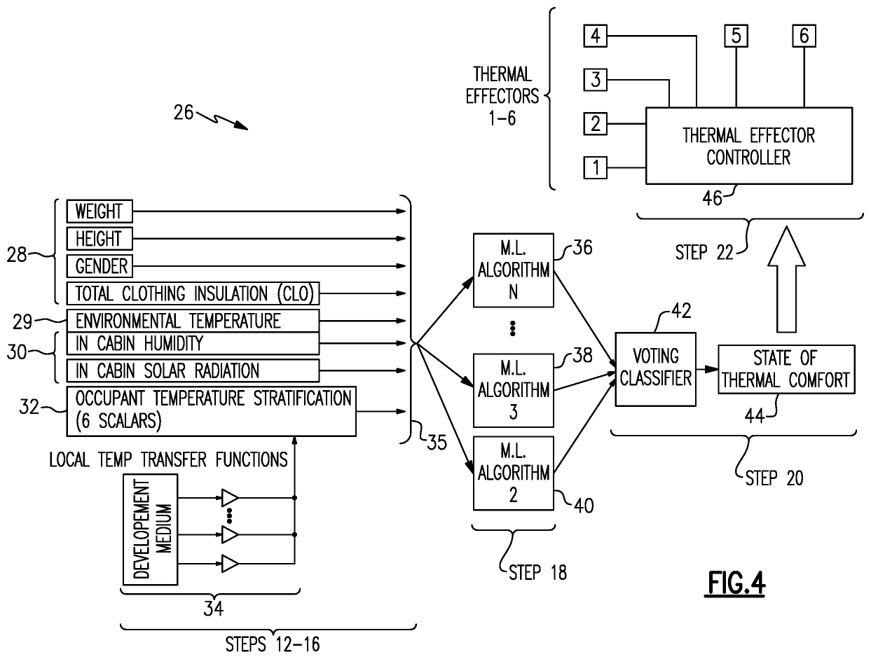

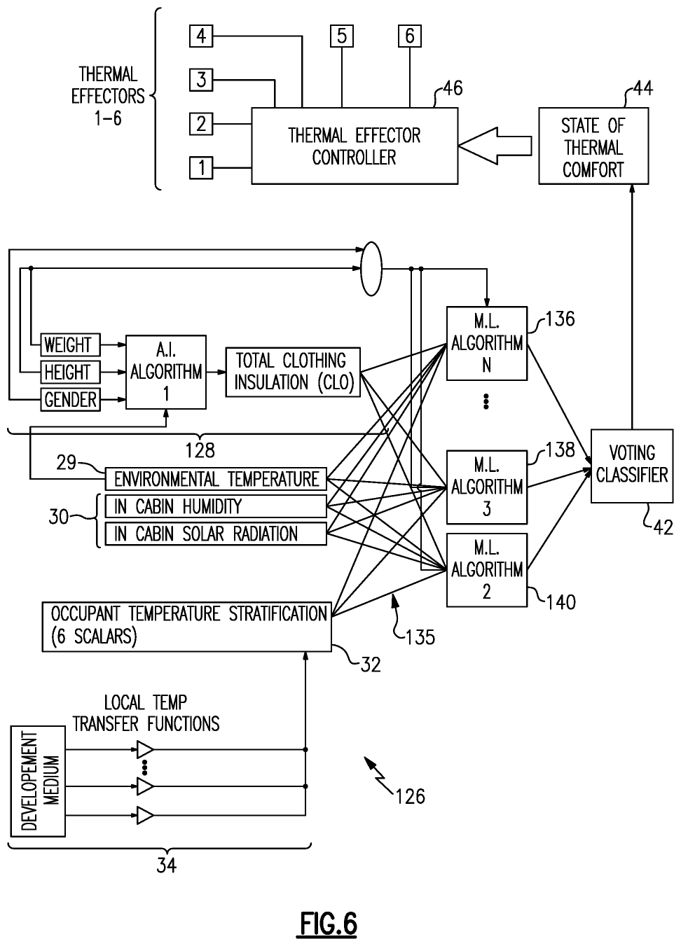

After the neural net has been trained using a data set, the predicted relationship between the inputs and output for the given machine learning algorithm is established. This training process is reiterated for multiple machine learning algorithms providing multiple distinct algorithm relationships f(x). In one example disclosed method 10, shown in FIG. 3, vehicle environmental conditions (29, FIGS. 4 and 6) are determined, as indicated at block 12. The vehicle environmental conditions include, for example, vehicle exterior temperature and vehicle exterior humidity. Cabin conditions (30, FIGS. 4 and 6) are also determined, as indicated at block 14. The cabin conditions include at least one of cabin temperature data, cabin humidity and cabin solar radiation. Occupant personal parameters (28, FIGS. 4 and 6) are determined, as indicated at block 16. Occupant personal parameters include, for example, occupant weight, occupant height and occupant gender, occupant age, occupant culture/region and/or occupant habit. These parameters may be sensed directly or indirectly, input manually or automatically from external devices (e.g., phones, watches or fitness trackers), or predicted using one or more algorithms.

The thermal comfort control method 10 utilizes the data provided from blocks 12, 14 and 16 to predict a multiple of occupant thermal comfort values, as indicated at block 18. The prediction is performed using a multiple of different machine learning algorithms generated as described above to provide the multiple occupant thermal comfort values. Using multiple algorithms provides a more representative sample size of the likely thermal comfort than the actual occupant is experiencing. Example machine learning algorithms include random forests 36, LightGBM 38, and Neural Nets 40. Other machine learning algorithms, such as Extremely Gradient Boosted Trees (XGBoost), Extremely Randomized Trees, Adaptive boosting, Logistic Regression, Support Vector Machines, and/or Naive Bayes classifiers may also be used.

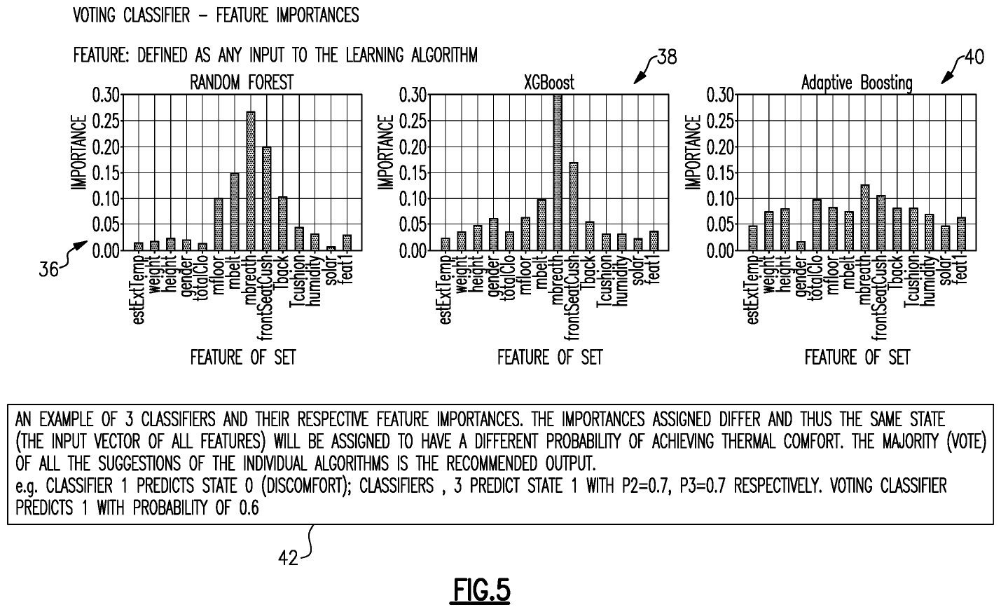

Due to the different techniques utilized in the various algorithms 36, 38, 40, different occupant thermal comfort values are generated as a result of the different weights given to the various inputs (see, FIG. 5). As indicated at block 20, the multiple occupant thermal comfort values are evaluated with a voting classifier 42 to provide a single estimated occupant thermal comfort, as only one thermal comfort serves as the basis for controlling the thermal effectors. The quality of the algorithms is evaluated using techniques such as the Matthews Correlation Coefficient (MCC), Average Precision Score (APS) and/or Balanced Accuracy Score (BAS). Thus, the estimated occupant thermal comfort is then used to regulate one or more thermal effectors in order to achieve desired occupant thermal comfort. The voting classifier 42 may use majority hard-voting or probabilistic hard-voting to arrive at the estimated occupant thermal comfort, examples of which are provided in FIG. 5.

Two example systems 26, 126 are respectively illustrated in FIGS. 4 and 3. The occupant personal parameters 28, vehicle environmental conditions 29, cabin conditions 30 and occupant temperature stratification 32 are fed into a thermal comfort model 35. In one example, the thermal comfort model relies upon an equivalent homogeneous temperature (EHT) to control the system. EHT represents the total thermal effects on an occupant as a measure of the occupant's heat loss, which produces a whole body thermal sensation. EHT takes into account the combined convective, conductive and radiative effects on the occupant and combines these effects into a single value, which is especially useful for modelling non-uniform thermal environments. One example calculation of EHT can be found in Han, Taeyoung and Huang, Linjie, “A Model for Relating a Thermal Comfort Scale to EHT Comfort Index,” SAE Technical Paper 2004-01-0919, 2004. As explained in this SAE paper, which is incorporated by reference in its entirety, the modeled thermal environment is affected by “breath” air temperature, mean radiant temperature (MRT), air velocity, solar load and relative humidity.

This application hereby incorporates by reference the co-pending PCT application entitled “Automotive Seat Based Microclimate System” which has a serial number of PCT/US2020/063349 and claims priority to U.S. Provisional patent Application No. 62/937,890 which was filed on Nov. 20, 2019 and has the same title, and to the co-pending PCT application entitled “Thermophysiologically-Based Microclimate Control System” which has a serial number of PCT/US2021/016723 and claims priority to U.S. Provisional Patent Application No. 62/970,409 which was filed on Feb. 5, 2020 and has the same title.

The occupant temperature stratification 32 may be calculated using transfer functions based upon empirical data 34. In the example, the occupant temperature stratification approximates the temperature at six different heights relative to the seated occupant. That is, the temperature vertical stratification adjusts the cabin air temperature for the level of stratification in that particular zone e.g. “breath level”.

The estimated occupant thermal comfort 44 is then used by the thermal effect controller 46 to regulate the thermal effectors 1-6. The thermal effectors include, for example, the seat 24, a steering wheel 30, a shifter 32, a mat 34 (such as a floor mat, a door panel, and/or a dash panel), a headliner 36, a microcompressor system 38, a cushion thermal conditioner 40, and/or a back/neck/head thermal conditioner 42.

A system 126, shown in FIG. 6, is similar to the system 26 shown in FIG. 4. In the example system 126, the occupant personal parameters 128 are estimated based upon pressure sensors in the seat to ultimately estimate an occupant clothing insulation value. According to the Harris-Benedict principle, such personal physiological parameters include weight, height, gender, age, fitness level, cultural preferences, etc. Several such parameters can be directly measured or evaluated, but direct measurement is cost prohibitive in a typical vehicle application. In order to make the determination of clothing more cost-effective, the disclosed invention relies upon simple, inexpensive pressure sensors on or near the surface of the seat that are used to generate information on weight, height, gender, etc. based upon the pressure distribution on the seating surface. Furthermore, a reading of the environmental temperature is used, and other information may also be referenced. The data are then fed into an algorithm that estimates an occupant clothing insulation value for a seated occupant. This clothing insulation value can then be used for the thermal comfort models used to control the thermal effectors, which provide a more accurate personal occupant comfort.

The individual inputs 135 provided by the vehicle environmental condition, cabin condition, and occupant personal parameter data is fed into the different machine learning algorithms 136, 138, 140 prior to predicting occupant thermal comfort, which potentially provides more variability than the system 26.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

In one alternate embodiment, the distinct machine learning algorithms can be replaced with a single machine learning algorithm that has been trained on different data sets. This method of training results in distinct machine learning algorithm relationships (f(x)). The distinct algorithm relationships are then treated in the same manner as the algorithm relationship from distinct machine learning algorithms.

Although an example embodiment has been disclosed, a worker of ordinary skill in this art would recognize that certain modifications would come within the scope of the claims. For that reason, the following claims should be studied to determine their true scope and content.

What is claimed is:

1. A method of controlling an occupant microclimate system, the method comprising the steps of:
determining vehicle environmental conditions;
determining occupant personal parameters;
predicting a multiple of occupant thermal comfort values based upon at least the environmental conditions, cabin temperature data, and occupant personal parameters, the predicting step performed using a multiple of different machine learning algorithm relationships to provide the multiple of occupant thermal comfort values;
evaluating the multiple of occupant thermal comfort values using a voting classifier to provide an estimated occupant thermal comfort; and
regulating at least one thermal effector based upon the estimated occupant thermal comfort.

2. The method of claim 1, wherein the vehicle environmental conditions include at least one of cabin conditions, vehicle exterior temperature and vehicle exterior humidity.

3. The method of claim 2, wherein the cabin conditions include at least two of the cabin temperature data, a cabin humidity and a cabin solar radiation.

4. The method of claim 3, wherein the cabin conditions include at least three of mean temperature at a cabin floor, mean temperature at an occupant belt line or waist, mean temperature at a breath level or face, temperature of a cushion between knees, temperature of a seat back, temperature of a seat cushion, and a difference between the temperatures at the breath level and at the cabin floor.

5. The method of claim 1, wherein the occupant personal parameters include at least two of occupant weight, occupant height, occupant gender, and occupant clothing.

6. The method of claim 1, wherein the multiple of machine learning algorithms include at least three of random forests, LightGBM, Neural Nets, Extremely Gradient Boosted Trees (XGBoost), Extremely Randomized Trees, Adaptive boosting, Logistic Regression, Support Vector Machines, and Naive Bayes classifiers, the evaluating step performed on calculated equivalent homogeneous temperatures.

7. The method of claim 6, wherein each of the multiple of machine learning algorithms is trained via identical training sets.

8. The method of claim 1, wherein the voting classifier chooses among the multiple of occupant thermal comfort values using a majority hard-voting process to select the estimated occupant thermal comfort.

9. The method of claim 1, wherein the voting classifier chooses among the multiple of occupant thermal comfort values using a probabilistic soft-voting process to select the estimated occupant thermal comfort.

10. The method of claim 1, wherein the thermal effectors are selected from the group comprising a climate controlled seat, a head rest/neck conditioner, a climate controlled headliner, a steering wheel, a heated gear shifter, a heater mat, and a mini-compressor system.

11. A microclimate control system for an occupant, comprising:
a first input device configured to provide vehicle environmental conditions;
a second input device occupant personal parameters;
at least one thermal effector configured to heat and/or cool an occupant; and
a controller configured to predict a multiple of occupant thermal comfort values based upon the environmental conditions, cabin temperature data, and occupant personal parameters, the controller configured to perform the prediction using a multiple of different machine learning algorithms to provide the multiple of occupant thermal comfort values, the controller configured to evaluate the multiple of occupant thermal comfort values with a voting classifier to provide an estimated occupant thermal comfort, the controller configured to regulate the at least one thermal effector based upon the estimated occupant thermal comfort.

12. The system of claim 11, wherein the vehicle environmental conditions include at least one of cabin conditions, vehicle exterior temperature and vehicle exterior humidity.

13. The system of claim 12, wherein the cabin conditions include at least two of the cabin temperature, a cabin humidity and a cabin solar radiation.

14. The system of claim 13, wherein the cabin conditions include at least three of a mean temperature at a cabin floor, a mean temperature at an occupant belt line or waist, a mean temperature at a breath level or face, a temperature of a cushion between the knees, a temperature of a seat back, a temperature of a seat cushion, and a difference between temperatures at the breath level and at the cabin floor.

15. The system of claim 11, wherein the second input device is at least one array of pressure sensors in a seat, and the occupant personal parameters include at least two of occupant weight, occupant height, occupant gender, and occupant clothing.

16. The system of claim 11, wherein the multiple of machine learning algorithms relationship ships include machine learning algorithm relationships determined using at least three of random forests, LightGBM, Neural Nets, Extremely Gradient Boosted Trees (XGBoost), Extremely Randomized Trees, Adaptive boosting, Logistic Regression, Support Vector Machines, and Naive Bayes classifiers, the evaluating step performed on calculated equivalent homogeneous temperatures.

17. The system of claim 11, wherein the voting classifier chooses among the multiple of occupant thermal comfort values based upon one of majority hard-voting and probabilistic soft voting to select the estimated occupant thermal comfort.

18. The system of claim 11, wherein the thermal effectors are selected from the group comprising a climate controlled seat, a head rest/neck conditioner, a climate controlled headliner, a steering wheel, a heated gear shifter, a heater mat, and a mini-compressor system.

19. The system of claim 11, wherein the multiple of machine learning algorithm relationships includes at least three machine learning relationships determined using a single machine learning algorithm and at least three data sets.
